(19) United States
(12) Patent Application Publication
(10) Pub. No.: US 2026/0231094 A1
(43) Pub. Date: Aug. 6, 2026

(54) METHODS FOR NETWORK-CENTRIC RESOURCE ALLOCATION FOR SIDELINK POSITIONING

(71) Applicant: Continental Automotive Technologies GmbH, Hannover (DE)

(72) Inventors: Reuben George Stephen, Singapore (SG); Rikin Shah, Langen, Hessen (DE); Andreas Andrae, Frankfurt am Main (DE); David Gonzalez Gonzalez, Egelsbach, Hessen (DE)

(73) Assignee: Continental Automotive Technologies GmbH, Hannover (DE)

(21) Appl. No.: 19/151,580

(22) PCT Filed: Feb. 7, 2024
(86) PCT No.: PCT/EP2024/053064

§ 371 Date: Jul. 28, 2025

(30) Foreign Application Priority Data
Feb. 7, 2023 (DE) 10 2023 200 976.5

(51) Int. Cl. H04W 64/00; H04W 72/25

(52) U.S. Cl. CPC H04W 64/00; H04W 72/25

(57) ABSTRACT

Methods for Network-Centric Resource Allocation for Sidelink Positioning within a wireless communication system with at least one user equipment, wherein at least one user equipment initiates an indirect or/and a direct resource allocation for a Sidelink positioning procedure and the positioning procedure itself is triggered by a user equipment or any other node.

### CROSS REFERENCE TO RELATED APPLICATIONS

This application is the U.S. National Phase application of PCT International Application No. PCT/EP2024/053064, filed Feb. 7, 2024, which claims priority to German Patent Application No. 102023200976.5, filed Feb. 7, 2023, the contents of such applications being incorporated by reference herein.

### TECHNICAL FIELD

The present disclosure relates methods for Network-Centric Resource Allocation for Sidelink Positioning, protocol and messages to be exchanged for network-centric resource allocation for SL positioning, including the case when one or more UEs do not belong to the same cell.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic. V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

EP 4060923 A1, incorporated herein by reference, discloses a pre-configured positioning reference signal (PRS) transmission method for sidelink positioning, and an apparatus therefor. A method for performing, by means of a positioning terminal, on-demand positioning in a new radio-vehicle to everything (NR-V2X) communication system, according to one aspect, comprises the steps of: transmitting a request PRS through a sidelink channel; receiving a response PRS corresponding to the request PRS from a neighboring terminal through the sidelink channel; receiving a measurement result corresponding to the request PRS from the neighboring terminal; and performing positioning on the basis of the response PRS and the measurement result, wherein the positioning terminal transmits, to the neighboring terminal, resource allocation information for transmission of the response PRS corresponding to the request PRS, and the measurement result may be received through a resource for V2X data transmission.

US2016095092 A1, incorporated herein by reference, discloses User Equipment (UE) comprising processing circuitry to connect with a cellular network; detect or connect with one or more additional UEs to form a direct connection with the one or more additional UEs; receive, from the cellular network, information allocating a portion of radio spectrum resources, as radio spectrum resources that are dedicated to exchanging signal location parameters that relate to information relevant to UE location determination;
receive, via the direct connection with the one or more additional UEs and using the allocated portion of the radio spectrum resources, one or more of the signal location parameters; and determine, based on the received one or more of the signal location parameters, a location of the UE.

EP 4072195 A1, incorporated herein by reference, discloses a method and device for a first terminal to transmit a positioning reference signal (PRS) through a physical sidelink feedback channel (PSFCH) in a wireless communication system supporting sidelink communication according to various embodiments. Disclosed are a method and device, wherein the method comprises the steps of: allocating a first frequency resource region for a PRS within a resource region for the PSFCH so that the PRS is multiplexed with a feedback signal; transmitting allocation information on the first frequency resource region; and transmitting the PRS and the feedback signal through the PSFCH on the basis of the allocation information, wherein the size of the first frequency resource region is determined on the basis of the size of a pre-configured frequency resource for the feedback signal and the type of the multiplexing, and the allocation information includes information on the multiplexing type, the size of the first frequency resource region, and the start frequency of the first frequency resource.

US2022278797 A1, incorporated herein by reference, discloses a method in which a first apparatus performs sidelink communication is provided. The method may comprise: receiving a PSCCH from a second apparatus; receiving a PSSCH related to the PSCCH from the second apparatus; transmitting an SL PRS for sidelink positioning to the second apparatus; determining a PSFCH resource for transmitting a PSFCH to the second apparatus based on the PSCCH and the PSSCH; and transmitting the PSFCH to the second apparatus based on the PSFCH resource, wherein a time interval in which the SL PRS is transmitted and a time interval in which the PSFCH is transmitted may overlap each other.

US2020374656 A1, incorporated herein by reference, discloses a transceiver for a wireless communication system is configured to: communicate with at least one other transceiver of the system using a sidelink resource pool of the system; transmit signals on resources of the pool that are allocated to the transceiver on a period basis with equal length periods tperiodA; transmit a first signal on a first resource of the resources allocated to the transceiver, and receive a second signal from another transceiver of the system on a second resource, the second signal being transmitted by the other transceiver responsive to a reception of the first signal, the second signal being transmitted by the other transceiver on the second resource using the period tperiodA based on which the resources are allocated to the transceiver; determine a distance to the other transceiver based on a time troundA between the transmission of the first signal and the reception of the second signal from the other transceiver, and based on the period tperiodA based on which the resources are allocated to the transceiver.

WO 2022120817 A1, incorporated herein by reference, is a disclosure relate to coordinated positioning via sidelink resource. A first terminal device transmits a first message to a plurality of positioning terminal devices including a second terminal device. The first message indicates sidelink resources for transmitting reference signals from the plurality of positioning terminal devices to the first terminal device. Upon receiving the first message, the second terminal device determines a first sidelink resource for transmitting a first reference signal for positioning the first terminal device from the sidelink resources, and then transmits the first reference signal via the first sidelink resource to the first terminal device. Through this solution, a sidelink-based positioning solution can be implemented. In particular, even in the scenario of being partial coverage or being out of coverage, where at least part of the devices involved in the positioning procedure cannot access the network device, the resource allocation for transmitting RSs can be implemented.

WO 2022193314 A1, incorporated herein by reference, discloses methods and apparatuses for sidelink (SL) positioning. According to an embodiment of the present application, a method may include: receiving configuration information for SL positioning, wherein the configuration information for SL positioning includes at least one of: configuration of at least one panel pattern, wherein each panel pattern of the at least one panel pattern includes one or more panels; at least one resource allocation principle associated with the at least one panel pattern; and at least one beam allocation principle associated with the at least one panel pattern; and transmitting an SL positioning reference signal (SL-PRS) according to the received configuration information for SL positioning. Embodiments of the present application can support more efficient multiple-node UE positioning with low signaling overhead.

WO 2022184240 A1, incorporated herein by reference, discloses a user device for positioning based on sidelink, wherein the user device is configured to: obtain a sidelink, SL, positioning resource information, wherein the sidelink positioning resource information indicates a resource characteristic of a sidelink positioning reference signal, SL-PRS, a positioning assistance data, AD, or location information, LI; and perform sidelink positioning based on the sidelink positioning resource information.

Positioning Methods for SL Positioning are at least the following methods using SL measurements identified for possible introduction:
RTT-type solutions using SL
SL-AoA
SL-TDOA

Above identification does not necessarily imply their specification as separate methods nor specification of a unified positioning method for SL

With regards to SL positioning measurement report, following aspects are included.

Contents of the measurement report, that may include one or more SL positioning measurement(s), timestamp(s) associated with SL positioning measurement, quality metric(s) associated with SL positioning measurement, identification Information for SL positioning measurement.

Time domain behavior of measurement report (e.g., one-shot, triggered, aperiodic, semi-persistent, periodic)

Whether SL positioning measurements can be higher-layer report and/or a lower-layer report is considered.

Resource allocation for SL PRS, at least following schemes are known:
Scheme 1: Network-centrico peration e.g., similar to legacy Mode 1 solution), Network e.g., gNB, LMF, gNB& LMF allocates resources for SL PRS
Scheme 2: UE autonomous e.g., similar to legacy Mode 2 solution), at least one of UE(s) participating in SL positioning operation allocates resources for SL PRS Applicable regardless of network coverage.

Potential mechanisms, if needed, for SL PRS resource coordination across a number of transmitting UEs e.g., Inter-UE Coordination (IUC)-like solutions can be considered further.

Scheme 1 SL PRS resource allocation is proceeded by that, that the transmitting UE receives SL PRS resource allocation signaling from network. One or both of following options considered further for corresponding signaling:
Opt. 1: Through higher layers from LMF
Opt. 2: Through dynamic grants, or via configurations of configured grant type 1 or type 2 from gNB

With regards to SL Positioning resource allocation, either dedicated resource pool(s) and/or a shared resource pool(s) with SL communication can be (pre-) configured for SL PRS.

Following options are given for time-domain resource assignments and associated Tx UE behavior for SL PRS transmissions:
Periodic SL PRS, with SL PRS is transmitted periodically with a transmission periodicity; Any additional details, including whether higher layers can start/stop transmission, can be considered further during normative work.
Semi-persistent SL PRS with SL PRS transmitted periodically with transmission periodicity after activation and until deactivation.

Aperiodic SL PRS is proceeded by SL PRS transmitted at least once after either triggering or request (FFS); applicability of above options to SL PRS resource allocation schemes 1 and 2 respectively can be considered further. Details of Rx UE behavior can be separately discussed during normative work. Mechanism(s) to be used for activation/deactivation/triggering can be considered further. Resource allocation for SL-Positioning measurement reports are also known.

Some prior art exists which considers resource allocation aspects for SL positioning; however, none of them consider the situation where UEs can belong to different cells.

### SUMMARY OF THE INVENTION

This application gives a solution to how to implement network-centric resource allocation for SL positioning and how to coordinate network-centric resource allocation when UEs involved belong to different cells.

Methods for Network-Centric Resource Allocation for Sidelink Positioning within a wireless communication system with at least one user equipment (UE), characterized by, that at least one or more user equipment (UE) initiate an indirect or/and a direct resource allocation for positioning procedure and the positioning procedure itself is triggered by a UE or any other node.

In some embodiments of the method according to the first aspect, the method is characterized by, that, UEs involved in SL positioning belong to different serving cells in the wireless communication system.

In some embodiments of the method according to the first aspect, the method is characterized by, that, that the user equipment UE operates an indirect resource allocation, one of the UEs initiates positioning through its own serving cell or LMF and handles resource allocation for all UEs involved in the SL positioning.

In some embodiments of the method according to the first aspect, the method is characterized by, that, that SL positioning resource allocation is always routed through one in-coverage UE and the requesting UE is forwarding resource allocation to other UEs over SL and a requesting UE needs to forward resource allocation to other UEs over SL and Out-of-coverage UEs can be involved in positioning.

In some embodiments of the method according to the first aspect, the method is characterized by that, that the resource allocation by an in-coverage UE is triggered whenever the UE receives a trigger for any subset of or all the following from its own higher layer or from any other node in the network, whereby the trigger is a transmission and/or, reception of SL PRS or transmission and/or reception of at least one SL positioning measurement report or signal and/or data transmission related to SL positioning operation.

In some embodiments of the method according to the first aspect, the method is characterized by that, that, the In-coverage UE requests for and receives the UE ID(s) of all other UE(s) involved in the positioning operation and the Cell ID(s) of all other UE(s) involved in the positioning operation from all the other UEs involved in the positioning operation either before or after triggering the positioning procedure, and before the resource allocation request is raised

In some embodiments of the method according to the first aspect, the method is characterized by that, the UE ID(s) of all other UE(s) involved in the positioning operation and the Cell ID(s) of all other UE(s) involved are obtained by
any data or control channel within the dedicated RP, that the UE is using for positioning along with the other UE(s), and/or
any data or control channel within the shared RP that the UE is using for communication and positioning along with the other UE(s), and/or
any data or control channel within SL communication RP(s) which both the triggering UE and other UE(s) are using.

In some embodiments of the method according to the first aspect, the method is characterized by that, that, data channel is the Physical Sidelink Shared Channel (PSSCH) and the control channel is the Physical Sidelink Control Channel (PSCCH)

In some embodiments of the method according to the first aspect, the method is characterized by that, that the in-coverage triggering UE has obtained a resource allocation by gNB, in-coverage triggering UE identifies UE(s) that do not belong to its same cell based on their cell ID(s) and then sends a SR to its serving cell (gNB) to grant UL resources to send further information.

In some embodiments of the method according to the first aspect, the method is characterized by that, that SR, the UE requests for either, data and/or control channel resources on a dedicated RP for positioning, or data and/or control channel resources on a shared RP for positioning and communication, or data channel resources on a SL communication RP.

In some embodiments of the method according to the first aspect, the method is characterized by that, that, that SR also indicates the amount of UL resources required by the UE to send further information and as response to the SR by UE, gNB allocates UL resources for the UE to send further information about SR, UE sends at least the information to gNB over UL resources allocated to it, whereby the information contains types of resources to be scheduled, for each UE involved in the positioning procedure, the Index of RP on which resources are required and the timing/periodicity of resources required and/or type of positioning method.

In some embodiments of the method according to the first aspect, the method is characterized by that, that the UE which requires resources for SL positioning sends request to LMF, whereby it can be sent using existing LPP and this request contains:
UE ID(s) and cell ID(s) of all UE(s) involved
Number of UEs involved in the positioning procedure
Index of RP on which resources are required (if there are multiple RPs used by the UEs)
Type of resources required (e.g., SL-PRS resource, resources for measurement reports, etc)
Timing/periodicity of resources required (e.g., aperiodic/semi-persistent/periodic SL-PRS, several measurement reports in pre-defined sequence, etc.)

In some embodiments of the method according to the first aspect, the method is characterized by that, that
Target UE sends SR to gNB; gNB provides UL resources for target UE to send SL positioning resource allocation requirements; target UE sends resource allocation requirements for SL PRS transmissions by anchor UEs; this includes UE IDs of all anchor UE(s) and target UE and indication of which anchor UE(s) do not belong to same cell as target UE; gNB sends resource allocation grant for target and anchor UEs
Target UE forwards grant for anchor UE(s).
All anchor UE(s) perform the SL PRS transmission on allocated resources and target UE performs SL RSTD measurements for higher layer to compute its own position

In some embodiments of the method according to the first aspect, the method is characterized by that, that in-coverage UE whose higher layer triggered the positioning procedure sends indication to other UE(s) involved to initiate resource allocation; indication involves at least the following information
Type of resources required
Timing/periodicity of resources required
Preferred time-frequency location of resources
Index of RP on which resources are required

In some embodiments of the method according to the first aspect, the method is characterized by, that following information can be sent via.
Any control or data channel within dedicated RP(s) that the triggering UE is using for positioning along with the other UE(s).
Any control or data channel within shared RP(s) that the triggering UE is using for communication and positioning along with the other UE(s).
Any data channel within SL communication RP(s) that the triggering UE is using for communication along with the other UEs

In some embodiments of the method according to the first aspect, the method is characterized by that, that as response to the SR as response to the SR by each UE, the corresponding serving cell (gNB) allocates UL resources for each UE to send further information about SR, then UE sends at least the following information to the gNB over UL resources allocated to it
Type of resources required
Timing/periodicity of resources required
Preferred time-frequency location of resources
Index of RP on which resources are required

In some embodiments of the method according to the second aspect, the method is characterized by that in-coverage UE whose higher layer triggered the positioning procedure, or which triggers the resource allocation, sends indication to other UE(s) involved in the SL positioning procedure to initiate resource allocation, then each involved UE which requires resources for SL positioning sends request to LMF which can be sent using existing LPP.

In some embodiments of the method according to the second aspect, the method is characterized by, that the
Target UE sends resource allocation initiation to other UEs involved in positioning procedure.
Each UE sends SR to their respective gNB; gNB provides UL resources for each UE to send SL positioning resource allocation requirements; each UE sends resource allocation requirements for SL PRS transmissions; gNB sends resource allocation grant for each UE.
All anchor UE(s) perform the SL PRS transmission on allocated resources and target UE performs SL RSTD measurements for higher layer to compute its own position

In some embodiments of the method according to the third aspect, the method is characterized by, that the that after the UE raises the SR for UL resources and gNB grants UL resources for transmitting further information, the UE sends information on whether there are out of coverage UEs involved in positioning on the granted UL resources,
if there are out of coverage UEs involved, the gNB uses indirect resource allocation, and sends the resources to the UE which sent the SR, to be forwarded to all other UEs;
if there are no out of coverage UEs involved, the gNB may decide to use either direct or indirect resource allocation depending on the latency requirements, resources available, etc.
   If direct resource allocation is to be used, gNB sends indication to UE which sent SR to send indication to all involved UEs to initiate resource allocation requests on their own
   If indirect resource allocation is to be used, gNB sends indication to UE which sent SR to forward the resource allocation to corresponding UEs
whereby if LMF allocates resources instead of the gNB, the LMF decides between direct or indirect resource allocation and sends the appropriate indication to the requesting UE

According to a second aspect, the present disclosure relates to an apparatus for Network-Centric Resource Allocation for Sidelink Positioning, the apparatus comprising a wireless transceiver, a processor coupled with a memory in which computer program instructions are stored, said instructions being configured to implement steps of the method according to the first, second and third aspect.

According to a third aspect, the present disclosure relates to an in-coverage User Equipment comprising an apparatus according second aspect.

According to a forth aspect, the present disclosure relates to another User Equipment comprising an apparatus according second aspect.

According to a fifth aspect, the present disclosure relates to a serving gNB comprising an apparatus according to second aspect.

According to a sixth aspect, the present disclosure relates to a neighbour gNB comprising an apparatus according to second aspect.

According to a sixth aspect the present disclosure relates to a Wireless communication system for Network-Centric Resource Allocation for Sidelink Positioning, wherein the wireless communication systems comprises in-coverage user equipment according this aspect, another user Equipment according forth aspect, a serving gNB according fifth aspect and a neighbour gNB according sixth aspect, whereby the other user Equipment, a serving gNB and a neighbour gNB each comprises a processor coupled with a memory in which computer program instructions are stored, said instructions being configured to implement steps of the method according to the first, second and third aspect.

### BRIEF DESCRIPTION OF THE DRAWINGS

FIG. 1 shows the periodicity and the frequency for the resource's allocation for SL communication.

FIG. 2 shows dynamic SL grant DCI

FIG. 3 shows configured SL grant DCI

FIG. 4 shows the UL Scheduling Flow

FIG. 5 shows the protocol layering for LMF to UE signaling.

FIG. 6 shows the LPP PDU transfer between LMF and UE (network- and UE-triggered cases).

FIG. 7 shows

FIG. 8 shows the protocol layering for LMF to NG-RAN Signalling

FIG. 9 shows the NRPPa PDU Transfer between an LMF and NG-RAN node for UE Positioning

FIG. 10 shows NRPPa PDU Transfer between an LMF and NG-RAN for obtaining NG-RAN Data

FIG. 11 shows the two possible scenarios where either all UEs belong to the same cell or at least one anchor UE belongs to a different cell

FIG. 12 shows the indirect resource allocation (gNB) flowchart

FIG. 13 shows indirect resource allocation (gNB) flowchart in-coverage UE

FIG. 14 shows one embodiment of indirect resource allocation (gNB)

FIG. 15 shows the direct resource allocation (gNB(s)) flowchart

FIG. 16 shows direct resource allocation (gNBs) flowchart in-coverage UE

FIG. 17 shows direct resource allocation (gNBs) flowchart other UEs

FIG. 18 shows one embodiment of direct resource allocation (gNB(s))

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of aspects of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

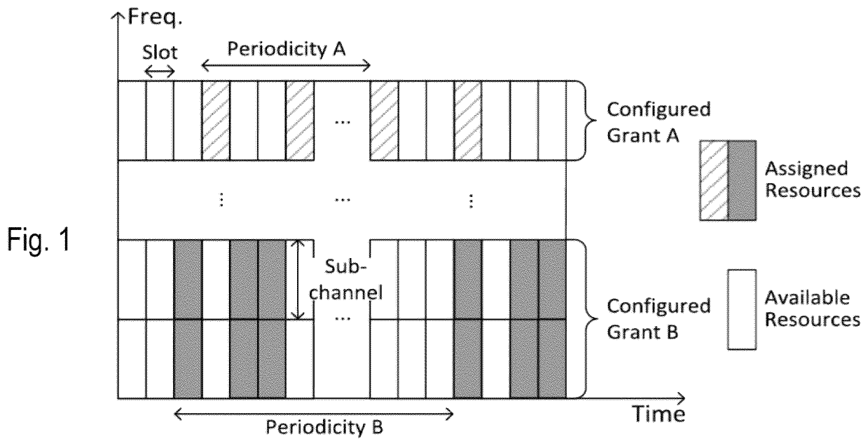

FIG. 1 shows the periodicity and the frequency for the resources allocation for SL communication. Mode 1 resource allocation for SL communication defined in TS 38.214, TS 38.211. gNB assigns and manages SL radio resources using NR Uu interface. UEs must be in network coverage. SL radio resources can be allocated from licensed carriers dedicated to SL communications or licensed carriers that share resources between SL and UL communications. The SL radio resources can be configured so that mode 1 and mode 2 use separate/shared resource pools. Mode 1 UEs notify mode 2 UEs of resources allocated for their future transmissions. Types of grants are possible: Dynamic grants (DG); Configured grants (CG): periodic sidelink resources configured semistatically by RRC

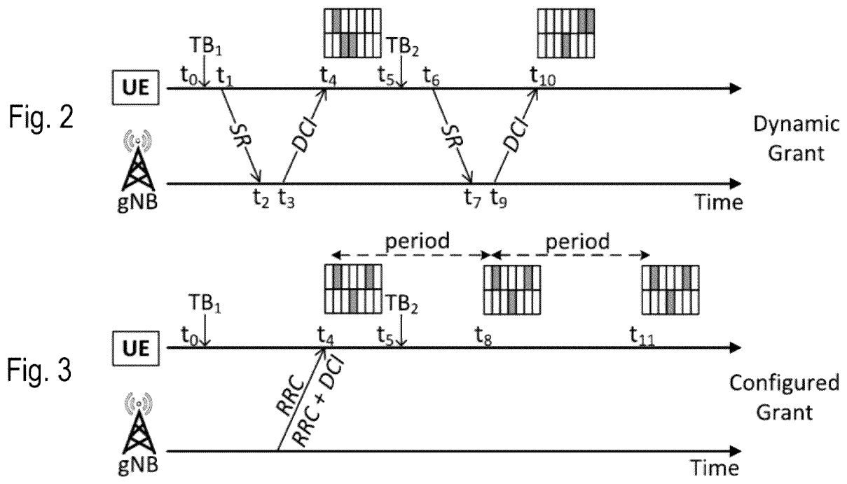

FIG. 2 shows dynamic SL grant DCI. FIG. 3 shows configured SL grant DCI. FIGS. 2 and 3 show mode 1 resource allocation for SL communication (Ref: TS 38.214, TS 38.211). Dynamic SL grant DCI can provide resources for one or multiple transmissions of a TB. SL configured grant: Type 1: configured once and can be used by UE immediately, until it is released by RRC signaling; Type 2: configured once but cannot be used until gNB sends UE DCI indicating activation, and only until another DCI indicates de-activation. Resources in both types recurring with periodicity which gNB will desire to match to characteristics of V2X traffic. gNB scheduling activity driven by UE reporting its sidelink traffic characteristics to the gNB, or by performing a sidelink BSR procedure similar to that on Uu to request a sidelink resource allocation from gNB.

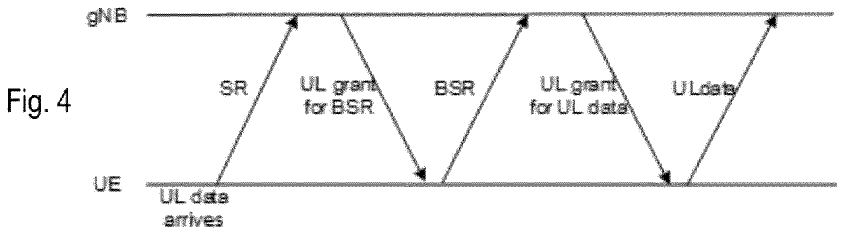

FIG. 4 shows the UL Scheduling Flow. SL SR follows similar flow as UL SR, which is given below:
Step 1: UE sends SR for requesting PUSCH resources for new transmission.
Step 2: gNB receives SR, and gNB knows that the UE has UL data for transmission, but gNB doesn't know the amount of UL data in UE buffer. So usually gNB firstly allocates PUSCH resource for BSR to the UE.
Step 3: UE sends BSR on the PUSCH resource allocated to the UE, and provides gNB the amount of UL data.
Step 4: gNB allocates PUSCH resource for UL data to the UE.
Step 5: UE transmits UL data on the PUSCH resource allocated to the UE.

The Location Management Function manages support of different location services for target UEs, including positioning of UEs and delivery of assistance data to UEs. Location Management Function may interact with serving gNB for a target UE to obtain position measurements for the UE. Furthermore, it may interact with a target UE to deliver assistance data if requested for a particular location service, or to obtain a location estimate if that was requested and may interact with multiple NG-RAN nodes to provide assistance data information for broadcasting. Assistance data information for broadcast may optionally be segmented and/or ciphered by the LMF. The LMF may also interact with AMFs to provide ciphering key data information to the AMF

For positioning of a target UE, LMF decides on position methods to be used, based on factors that may include the LCS Client type, the required QoS, UE positioning capabilities, gNB positioning capabilities, etc. LMF then invokes these positioning methods in the UE and serving gNB. The positioning methods may yield: a location estimate for UE-based position methods and/or positioning measurements for UE-assisted and network-based position methods LMF may combine all the received results and determine a single location estimate for the target UE (hybrid positioning). Additional information like accuracy of the location estimate and velocity may also be determined. The LMF may interact with the AMF to provide (updated) UE Positioning Capability to AMF and to receive stored UE Positioning Capability from AM

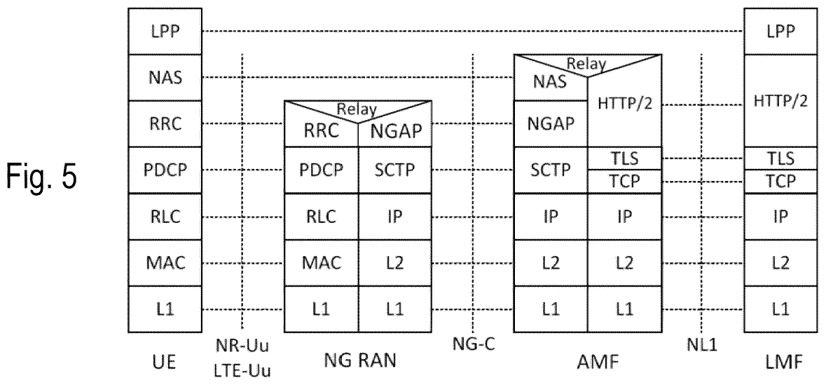

FIG. 5 shows the protocol layering for LMF to UE signaling. LPP PDU is carried in NAS PDU between the AMF and the UE.

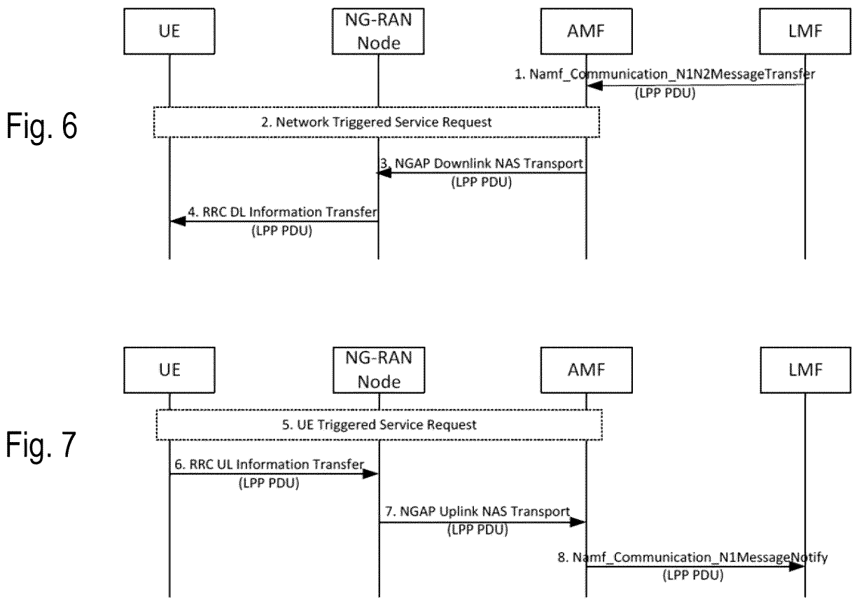

FIGS. 6 and 7 shows the LPP PDU transfer between LMF and UE (network- and UE-triggered cases).

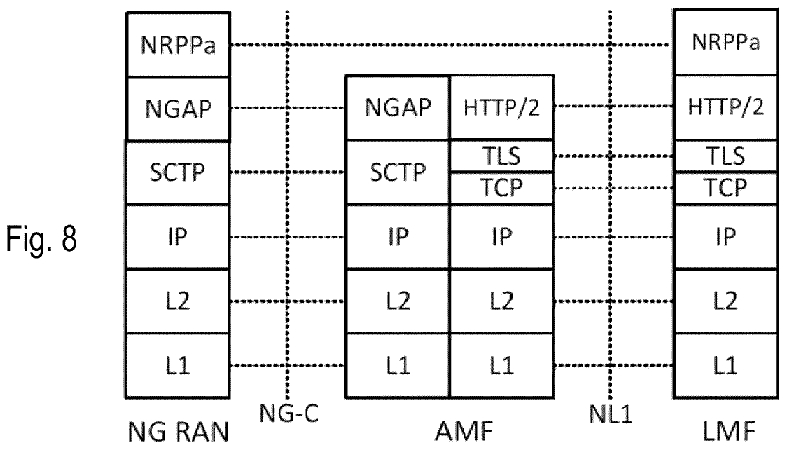

FIG. 8 shows the protocol layering for LMF to NG-RAN Signalling

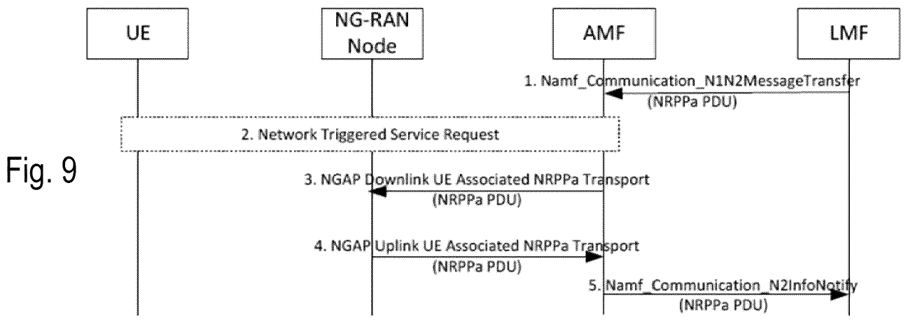

FIG. 9 shows the NRPPa PDU Transfer between an LMF and NG-RAN node for UE Positioning

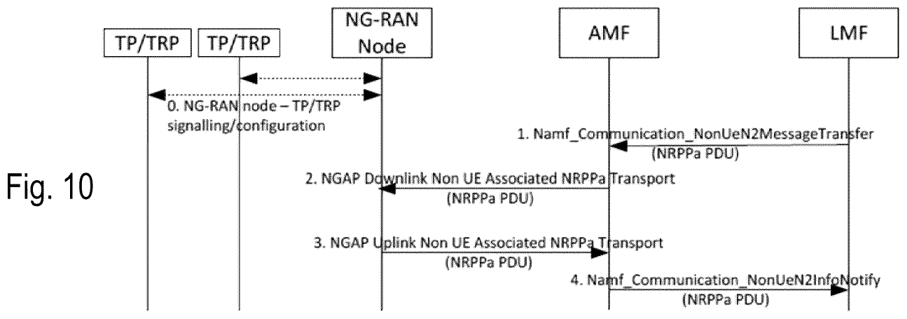

FIG. 10 shows NRPPa PDU Transfer between an LMF and NG-RAN for obtaining NG-RAN Data

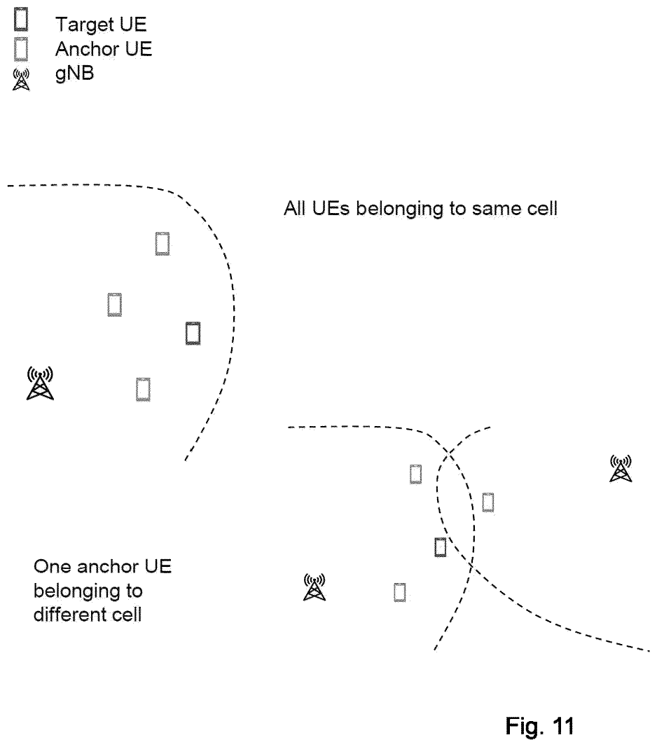

FIG. 11 shows the main idea. This application provides two separate methods for mode-1 like resource allocation for positioning:
1. Indirect resource allocation: One of the UEs (e.g., one whose higher layer initiates positioning) through its own serving cell or LMF, handles resource allocation for all UEs involved in the SL positioning. SL positioning resource allocation always routed through one in-coverage UE. Requesting UE needs to forward resource allocation to other UEs over SL. Out-of-coverage UEs can be involved in positioning
2. Direct resource allocation: All UEs involved in positioning coordinate first among each other on resources required, and then individually request for resources to their respective serving cells or LMFs. SL positioning resource allocation requested by each UE individually. Triggering UE needs to send indication to other UEs to initiate resource allocation. Out-of-coverage UEs cannot be involved in positioning
3. Direct/indirect resource allocation based on indication provided by initiating UE SL positioning resource allocation requested by one in-coverage UE, but decided by its serving cell based on additional information provided by UE. Depending on whether direct or indirect resource allocation is used, triggering UE needs to forward resource allocation or send indication to other UEs to initiate resource allocation. Out-of-coverage UEs can be involved in positioning

All methods can handle the case when UEs involved in SL positioning belong to different serving cells

The idea applies to cases where one or more in-coverage UEs initiate a resource allocation request as part of a positioning procedure; the positioning procedure itself may be triggered by a UE or any other node (e.g., gNB, LMF, etc.).

Resource allocation by an in-coverage UE is triggered whenever the UE receives a trigger for any subset of or all the following from its own higher layer or from any other node in the network:

Any transmission/reception of SL PRS, or any transmission/reception of SL positioning measurement report(s), or any other signal/data transmission related to SL positioning operation.

In-coverage UE requests for and receives the following information from all the other UEs involved in the positioning operation either before or after triggering the positioning procedure, and before the resource allocation request is raised:
UE ID(s) of all other UE(s) involved in the positioning operation
Cell ID(s) of all other UE(s) involved in the positioning operation

Above information can be obtained via:
Any data or control channel within the dedicated RP that the UE is using for positioning along with the other UE(s)
Any data (e.g., PSSCH) or control (e.g. PSCCH) channel within the shared RP that the UE is using for communication and positioning along with the other UE(s)
Any data (e.g., PSSCH) or control (e.g., PSCCH) channel within SL communication RP(s) which both the triggering UE other UE(s) are using
a. Resource allocation by gNB:

Once in-coverage triggering UE has obtained above information, it identifies UE(s) that do not belong to its same cell based on their cell ID(s) and then sends a SR to its serving cell (gNB) to grant UL resources to send further information In the SR, the UE requests for either:
Data and/or control channel resources on a dedicated RP for positioning, or Data and/or control channel resources on a shared RP for positioning and communication, or Data channel resources on a SL communication RP.

The SR also indicates the amount of UL resources required by the UE to send further information. As response to the SR by UE, gNB allocates UL resources for the UE to send further information about SR

UE sends at least the following information to gNB over UL resources allocated to it: Type(s) of resource(s) to be scheduled (e.g., configured or dynamic grant(s)) for each UE involved in the positioning procedure

One among the following:
Option 1: Number of UEs involved in the positioning procedure
Option 2: Number of UEs in the same cell involved in the positioning procedure and UE ID(s) and cell ID(s) for those UE(s) which do not belong to the same cell

Index of RP on which resources are required (if there are multiple RPs used by the UEs)

Timing/periodicity of resources required (e.g., aperiodic/semi-persistent/periodic SL-PRS, several measurement reports in pre-defined sequence, etc.)

Optionally, the information sent by the UE could also contain: Type of positioning method (e.g., RTT, SL-TDOA, SL-AoA, etc.)

On receiving above information, gNB allocates resources to all involved UEs as indicated by the UE which sent the SR

If one or more involved UE(s) (other than in-coverage UE which sent SR) belongs to different cell:
i. Option 1: gNB sends at least the following to the UE which sent the SR:

An indication to forward resource allocation to the UE(s) in different cell(s). Resource allocation for the in-coverage UE which sent the SR in RRC (for configurable grant) or DCI (for dynamic grant) or a combination of both, to the in-coverage UE

Optionally, the resource allocation sent by gNB may also include:
Dynamic/configurable grants of SL resources for forwarding the resource allocation to other UEs

Indication that these dynamic/configurable grants are for transmitting the resource allocation indication to other UE(s)

These SL resource allocations can be either within the dedicated RP or within the shared RP used for SL positioning by the UE which sent the SR

If gNB does not indicate separate SL resources for forwarding resource allocation to other UEs, the UE forwards the resource allocation on any other available SL resources
ii. Option 2: gNB sends resource allocation for other cell UE(s) via their respective serving gNBs using the X2 interface based on cell ID(s) indicated by UE which sent SR

If all involved UEs belong to the same cell gNB sends resource allocation for all UEs and indication to forward resource allocation to other UEs to UE which sent SR as in option 1 in i. above.

Positioning resource allocation can be configured grant or dynamic grant like in SL communication; on receiving the resources, the involved UE(s) proceed with the SL positioning procedure/computation.
b. Resource allocation by LMF:

UE which requires resources for SL positioning sends request to LMF; can be sent using existing LPP

Request contains at least the following information:
UE ID(s) and cell ID(s) of all UE(s) involved
Number of UEs involved in the positioning procedure
Index of RP on which resources are required (if there are multiple RPs used by the UEs)
Type of resources required (e.g., SL-PRS resource, resources for measurement reports, etc)
Timing/periodicity of resources required (e.g., aperiodic/semi-persistent/periodic SL-PRS, several measurement reports in pre-defined sequence, etc.)

Optionally, the request could also contain:
Type of positioning method (e.g., RTT, SL-TDOA, SL-AoA, etc.)

LMF allocates the requested resources to the UE which sent the resource allocation request by routing the resource allocation via the serving cell of the requesting UE using NRPPa and LPP

Like mentioned, the resource allocation includes the resources for all involved UEs, and may also include SL resources for the UE to forward the resource allocations to the other UEs

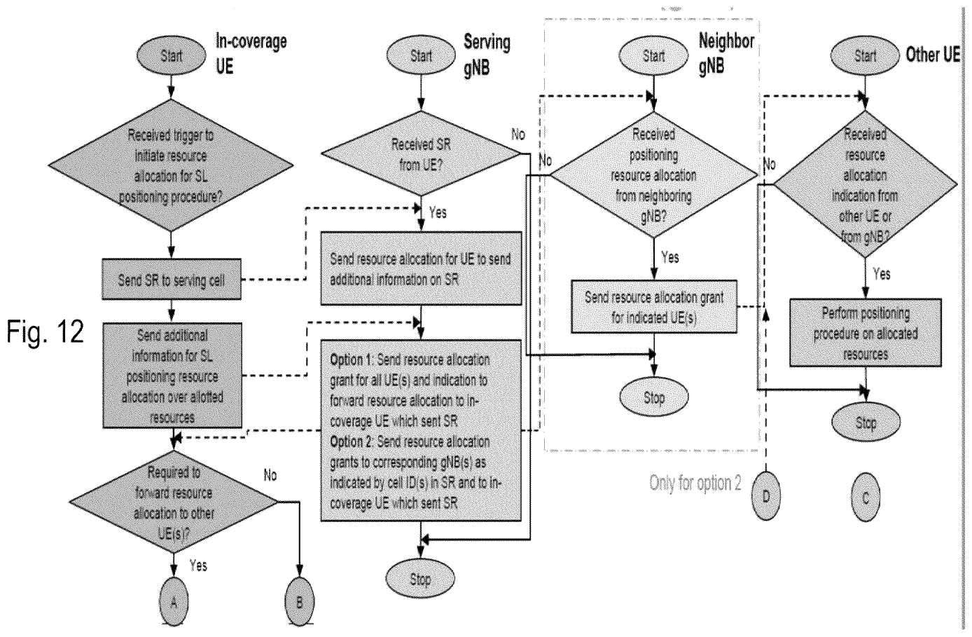

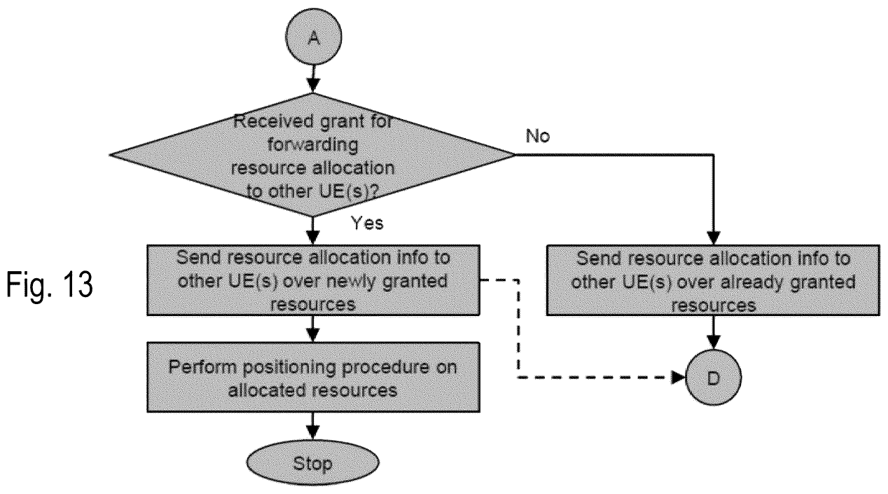

Resource allocation from the LMF can be directly received by the UE as an LPP message, or instead the serving gNB can decode the messages from LMF and then provide the UEs with configured/dynamic grants like in FIG. 12 and FIG. 13 as the case may be new behavior.

FIG. 12 shows the indirect resource allocation (gNB) flowchart

FIG. 13 shows indirect resource allocation (gNB) flowchart in-coverage UE

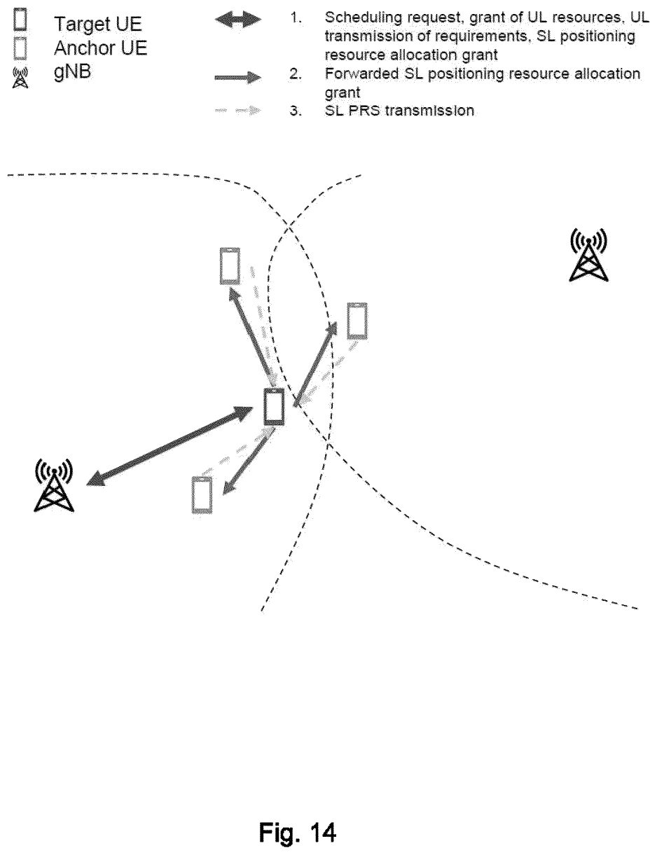

FIG. 14 shows one embodiment of indirect resource allocation (gNB). This embodiment 1 describes the indirect resource allocation (gNB): Consider SL-TDOA operating like DL-TDOA, where multiple anchor nodes transmit SL PRS to a target UE, and target UE performs SL RSTD measurement. Assume that at least one anchor UE belongs to a different cell from the target UE. Assume that resource allocation is performed by serving gNB of target UE. Assume target UE receives trigger for SL-TDOA positioning from higher layer.

Steps followed according to proposed method are:
1. Target UE sends SR to gNB; gNB provides UL resources for target UE to send SL positioning resource allocation requirements; target UE sends resource allocation requirements for SL PRS transmissions by anchor UEs; this includes UE IDs of all anchor UE(s) and target UE and indication of which anchor UE(s) do not belong to same cell as target UE; gNB sends resource allocation grant for target and anchor UEs
2. Target UE forwards grant for anchor UE(s)
3. All anchor UE(s) perform the SL PRS transmission on allocated resources and target UE performs SL RSTD measurements for higher layer to compute its own position

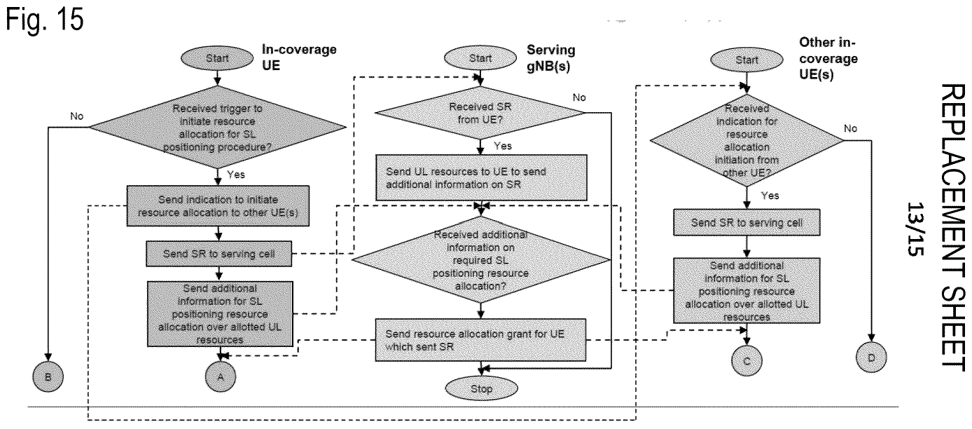

FIG. 15 shows the direct resource allocation (gNB(s)) flowchart. It shows the a. Resource allocation by gNB(s):

In-coverage UE whose higher layer triggered the positioning procedure sends indication to other UE(s) involved to initiate resource allocation; indication involves at least the following information:
Type of resources required (e.g., SL-PRS resource, resources for measurement reports, etc)
Timing/periodicity of resources required (e.g., aperiodic/semi-persistent/periodic SL-PRS or several measurement reports in pre-defined sequence, etc.)
Preferred time-frequency location of resources (to avoid conflicting resource allocation by different gNB(s))
Index of RP on which resources are required (if there are multiple RPs used by the UEs)

Optionally, indication may also include:
Type of positioning method (e.g., RTT, SL-TDOA, SL-AoA, etc.)
Number of UEs involved in the positioning procedure

Above information can be sent via:
Any control or data channel within dedicated RP(s) that the triggering UE is using for positioning along with the other UE(s)
Any control or data channel (e.g., PSCCH or PSSCH or any new control or data channel) within shared RP(s) that the triggering UE is using for communication and positioning along with the other UE(s)
Any data channel (e.g., PSSCH) within SL communication RP(s) that the triggering UE is using for communication along with the other UE(s)

When any UE other than the triggering UE receives an indication for resource allocation for a positioning procedure from the triggering UE, it sends an SR to its own serving cell (gNB)

In SR, every UE requests for either:
Data and/or control channel resources on a dedicated RP for positioning, or
Data and/or control channel resources on a shared RP for positioning and communication, or
Data channel resources on a SL communication RP

As response to the SR by each UE, the corresponding serving cell (gNB) allocates UL resources foreach UE to send further information about SR

Then UE sends at least the following information to the gNB over UL resources allocated to it:
Type of resources required (e.g., SL-PRS resource, resources for measurement reports, etc)
Timing/periodicity of resources required (e.g., aperiodic/semi-persistent/periodic SL-PRS or several measurement reports in pre-defined sequence, etc.)
Preferred time-frequency location of resources (to avoid conflicting resource allocation by different gNB(s))
Index of RP on which resources are required (if there are multiple RPs used by the UEs)

Optionally, indication may also include:
Type of positioning method (e.g., RTT, SL-TDOA, SL-AoA, etc.)
Number of UEs involved in the positioning procedure

On receiving the above information, each gNB allocates requested resources to the corresponding UE which sent the SR

The resources consist of dynamic/configurable grants of SL resources for performing positioning-related signal transmissions or data exchange

These SL resource allocations can be either within a dedicated RP or within a shared RP used for SL positioning by the UE which sent the SR, depending on the information given by the UE
b. Resource allocation by LMF:

Like in FIG. 14, in-coverage UE whose higher layer triggered the positioning procedure, or which triggers the resource allocation, sends indication to other UE(s) involved in the SL positioning procedure to initiate resource allocation

Then each involved UE which requires resources for SL positioning sends request to LMF; can be sent using existing LPP

Request contains at least the following information:
Index of RP on which resources are required (if there are multiple RPs used by the UEs). Type of resources required (e.g., SL-PRS resource, resources for measurement reports, etc). Timing/periodicity of resources required (e.g., aperiodic/semi-persistent/periodic SL-PRS, several measurement reports in pre-defined sequence, etc.)

Optionally, the request could also contain:
Type of positioning method (e.g., RTT, SL-TDOA, SL-AoA, etc.)
Number of UEs involved in the positioning procedure

LMF allocates the requested resources to each UE which sent the resource allocation request involved in positioning by routing the resource allocation via the respective serving cells (gNBs) using NRPPa and LPP

Resource allocation from the LMF can be directly received by the UE as an LPP message, or instead the respective serving gNB can decode the messages from LMF and then provide the UEs with configured/dynamic grants like in slides 25 and 26 as the case may be

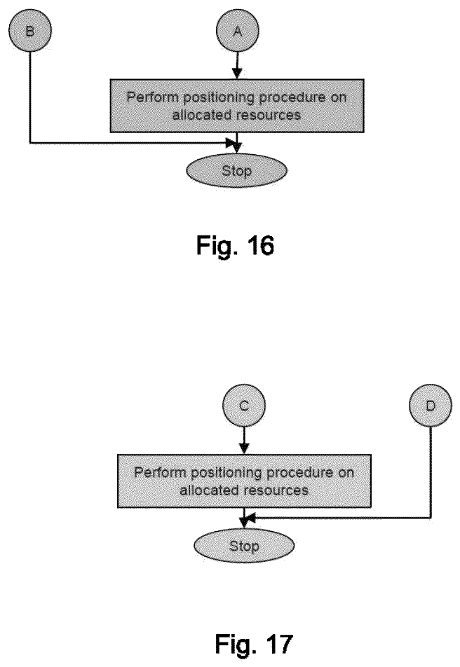

FIG. 16 shows direct resource allocation (gNBs) flowchart in-coverage UE

FIG. 17 shows direct resource allocation (gNBs) flowchart other UEs

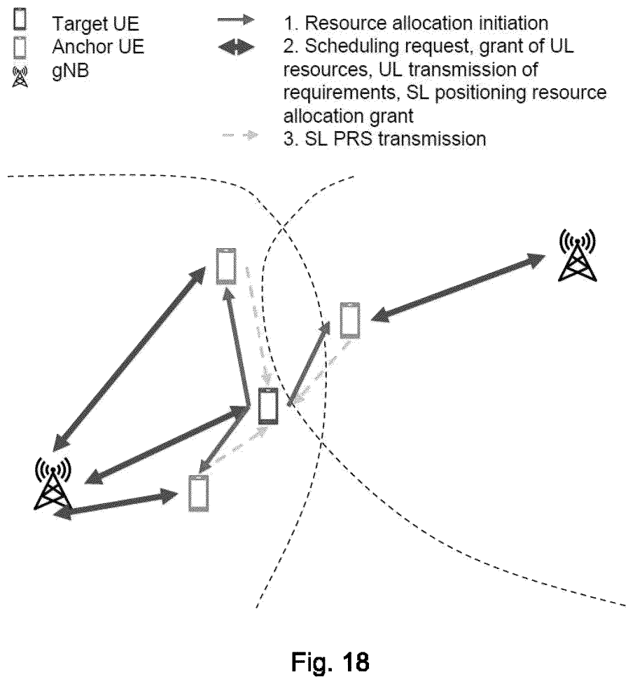

FIG. 18 shows one embodiment of direct resource allocation (gNB(s))

### Embodiment 2 Direct Resource Allocation (gNB(s))

Consider SL-TDOA operating like DL-TDOA, where multiple anchor nodes transmit SL PRS to a target UE, and target UE performs SL RSTD measurement Assume that at least one anchor UE belongs to a different cell from the target UE Assume that resource allocation is performed by the respective gNBs Assume target UE receives trigger for SL-TDOA positioning from higher layer

Steps followed according to proposed method are:
1. Target UE sends resource allocation initiation to other UEs involved in positioning procedure
2. Each UE sends SR to their respective gNB; gNB provides UL resources for each UE to send SL positioning resource allocation requirements; each UE sends resource allocation requirements for SL PRS transmissions; gNB sends resource allocation grant for each UE
3. All anchor UE(s) perform the SL PRS transmission on allocated resources and target UE performs SL RSTD measurements for higher layer to compute its own position

### Solution 3, Direct or Indirect Resource Allocation Decided by Serving Cell

In this solution, after the UE raises the SR for UL resources and gNB grants UL resources for transmitting further information, the UE sends information on whether there are out of coverage UEs involved in positioning on the granted UL resources If there are out of coverage UEs involved, the gNB uses indirect resource allocation, and sends the resources to the UE which sent the SR, to be forwarded to all other UEs

If there are no out of coverage UEs involved, the gNB may decide to use either direct or indirect resource allocation depending on the latency requirements, resources available, etc.

If direct resource allocation is to be used, gNB sends indication to UE which sent SR to send indication to all involved UEs to initiate resource allocation requests on their own

If indirect resource allocation is to be used, gNB sends indication to UE which sent SR to forward the resource allocation to corresponding UEs

Similarly, if LMF allocates resources instead of the gNB, the LMF decides between direct or indirect resource allocation and sends the appropriate indication to the requesting UE

New WID on Expanded and Improved NR Positioning was approved in RAN #98-e in December 2022, and work will commence in 2023; following is a part of WID: Specify support of resource allocation for SL PRS: Including resource allocation Scheme 1 and Scheme 2, where Scheme 1 corresponds to a network-centric SL PRS resource allocation and Scheme 2 corresponds to UE autonomous SL PRS resource allocation [RAN1]. This application provides a systematic method for network-centric resource allocation including cases where the UEs belong to different cells. Unlike resource allocation for SL communication, for SL positioning, the UE(s) need to coordinate among themselves to effectively utilize resources allocated by the network.

Abbreviations

| | |
|---|---|
| AMF: | access and mobility management function |
| AoA: | angle of arrival |
| BSR: | buffer status report |
| DCI: | downlink control information |
| FFS: | for further study |
| LCS: | location server |
| LMF: | location management function |
| LPP: | LTE positioning protocol |
| LTE: | long term evolution |
| NR: | new radio |
| NRPPa: | NR positioning protocol a |
| PDU: | protocol data unit |
| PRS: | positioning reference signal |
| PUSCH: | physical uplink shared channel |
| RAN: | radio access network |
| RTT: | round trip time |
| SL: | sidelink |
| SR: | scheduling request |
| TDOA: | time difference of arrival |
| UE: | user equipment |
| UL: | uplink |
| WID: | work item description |

1. A method for Network-Centric Resource Allocation for Sidelink Positioning within a wireless communication system with at least one user equipment, wherein at least one or more user equipment initiates an indirect or/and a direct resource allocation for performing a Sidelink positioning procedure and wherein the positioning procedure itself is triggered by a UE or any other node.

2. The method according to claim 1, wherein, at least one UE(s) involved in SL positioning belong to different serving cells in the wireless communication system.

3. The method according to claim 1, wherein that when the user equipment operates an indirect resource allocation, one of the in-coverage UEs initiates SL positioning through its own serving cell or location management function and handles resource allocation for all UEs involved in the SL positioning.

4. The method according to claim 1 wherein SL positioning resource allocation is always routed through one in-coverage UE and the requesting UE is forwarding resource allocation to other UEs over SL and Out-of-coverage UEs can be involved in positioning.

5. The method according to claim 1 wherein, characterize the resource allocation by an in-coverage UE is triggered whenever the UE receives a trigger for any subset of or all the following from its own higher layer or from any other node in the network, whereby the trigger is a transmission and/or, reception of SL PRS or transmission and/or reception of at least one SL positioning measurement report or signal and/or data transmission related to SL positioning operation.

6. The method according to claim 1 wherein, the In-coverage UE requests for and receives the UE ID(s) of all other UE(s) involved in the positioning operation and the Cell ID(s) of all other UE(s) involved in the positioning operation from all the other UEs involved in the positioning operation either before or after triggering the positioning procedure, and before the resource allocation request is raised

7. The method according to claim 1 wherein, the UE ID(s) of all other UE(s) involved in the positioning operation and the Cell ID(s) of all other UE(s) involved are obtained by
any data or control channel within the dedicated resource pool, that the UE is using for positioning along with the other UE(s), and/or
any data or control channel within the shared RP that the UE is using for communication and positioning along with the other UE(s), and/or
any data or control channel within SL communication RP(s) which both the triggering UE and other UE(s) are using.

8. The method according to claim 7 wherein, data channel is the Physical Sidelink Shared Channel and the control channel is the Physical Sidelink Control Channel (PSCCH).

9. The method according to claim 8, wherein, the UE requests for either, data and/or control channel resources on a dedicated RP for positioning, or data and/or control channel resources on a shared RP for positioning and communication, or data channel resources on a SL communication RP and the in-coverage triggering UE has obtained a resource allocation by gNB, in-coverage triggering UE identifies UE(s) that do not belong to its same cell based on their cell ID(s) and then sends a scheduling request (SR) to its serving cell (gNB) to grant UL resources to send further information.

10. The method according to claim 9, wherein, the SR also indicates the amount of UL resources required by the UE to send further information and as response to the SR by UE, gNB allocates UL resources for the UE to send further information about SR, UE sends at least the information to gNB over UL resources allocated to it, whereby the information contains types of resources to be scheduled, for each UE involved in the positioning procedure, the Index of RP on which resources are required and the timing/periodicity of resources required and/or type of positioning method.

11. The method according to claim 9, wherein, the UE which requires resources for SL positioning sends request to LMF, whereby the request can be sent using the existing Long Term Evolution (LTE) Positioning Protocol (LPP) and this request contains:
UE ID(s) and cell ID(s) of all UE(s) involved
Number of UEs involved in the positioning procedure
Index of RP on which resources are required (if there are multiple RPs used by the UEs)
Type of resources required (e.g., SL-PRS resource, resources for measurement reports, etc)
Timing/periodicity of resources required (e.g., aperiodic/semi-persistent/periodic SL-PRS, several measurement reports in pre-defined sequence, etc.).

12. The method according to claim 1 wherein, the in-coverage UE whose higher layer triggered the positioning procedure sends indication to other UE(s) involved to initiate resource allocation; indication involves at least the following information
Type of resources required
Timing/periodicity of resources required
Preferred time-frequency location of resources
Index of RP on which resources are required.

13. The method according to claim 12, characterized by that, that following information can be sent via
Any control or data channel within the dedicated RP(s) that the triggering UE is using for positioning along with the other UE(s)
Any control or data channel within the shared RP(s) that the triggering UE is using for communication and positioning along with the other UE(s)
Any data channel within the SL communication RP(s) that the triggering UE is using for communication along with the other UEs.

14. The method according to claim 13, wherein, as response to the SR by each UE, the corresponding serving cell (gNB) allocates UL resources for each UE to send further information about SR, then UE sends at least the following information to the gNB over UL resources allocated to it
Type of resources required
Timing/periodicity of resources required
Preferred time-frequency location of resources
Index of RP on which resources are required.

15. The method according to claim 1 wherein, an in-coverage UE whose higher layer triggered the positioning procedure, or which triggers the resource allocation, sends indication to other UE(s) involved in the SL positioning procedure to initiate resource allocation, then each involved UE which requires resources for SL positioning sends request to the LMF which can be sent using existing LPP.

16. The method according to claim 1, wherein after the UE raises the SR for UL resources and gNB grants UL resources for transmitting further information, the UE sends information on whether there are out of coverage UEs involved in positioning on the granted UL resources,
if there are out of coverage UEs involved, the gNB uses indirect resource allocation, and sends the resources to the UE which sent the SR, to be forwarded to all other UEs;
if there are no out of coverage UEs involved, the gNB may decide to use either direct or indirect resource allocation depending on the latency requirements, resources available, etc.
If direct resource allocation is to be used, gNB sends indication to UE which sent SR to send indication to all involved UEs to initiate resource allocation requests on their own
If indirect resource allocation is to be used, gNB sends indication to UE which sent SR to forward the resource allocation to corresponding UEs
whereby if LMF allocates resources instead of the gNB, the LMF decides between direct or indirect resource allocation and sends the appropriate indication to the requesting UE.

17. An apparatus for Network-Centric Resource Allocation for Sidelink Positioning, the apparatus comprising a wireless transceiver, a processor coupled with a memory in which computer program instructions are stored, said instructions being configured to implement steps of claim 1.

18. In-coverage User Equipment comprising an apparatus according to claim 17.

19. Other User Equipment comprising an apparatus according to claim 17.

20. Serving gNB comprising an apparatus according to claim 17.

21. Neighbour gNB comprising an apparatus according to claim 17.

22. A wireless communication system for Network-Centric Resource Allocation for Sidelink Positioning, wherein the wireless communication systems comprises in-coverage user equipment comprising a wireless transceiver and a processor coupled with a memory in which computer program instructions are stored, another user Equipment, a serving gNB and a neighbour gNB, wherein the other user Equipment, a serving gNB and a neighbour gNB 24 each comprises a processor coupled with a memory in which computer program instructions are stored, said instructions being configured to implement steps the method of claim 1.
